(19) United States
(12) Patent Application Publication
(10) Pub. No.: US 2009/0241028 A1
(43) Pub. Date: Sep. 24, 2009

(54) COMPUTER SYSTEM FOR ADMINISTERING QUALITY OF LIFE QUESTIONNAIRES

(76) Inventor: Michael Iskedjian, Williamsville, NY (US)

Correspondence Address: JAECKLE FLEISCHMANN & MUGEL, LLP, 12 Fountain Plaza, Buffalo, NY, 14202-2292, US

(21) Appl. No.: 12/358,795

(22) Filed: Jan. 23, 2009

Related U.S. Application Data
(60) Provisional application No. 61/022,978, filed on Jan. 23, 2008.

(51) Int. Cl. G06F 3/01; G06F 17/30

(52) U.S. Cl. 715/727; 707/104.1; 705/10; 707/E17.044; 707/10

(57) ABSTRACT

The present invention includes in one embodiment, a computer survey system comprising a microprocessor, a display screen, a user input device and a database all in communication with the microprocessor. The microprocessor activates software that systematically administers a quality of life survey by displaying a plurality of quality of life questions on the display screen. The software requests responses from the participant using a user input device and stores the response in a database. The system further has a sound player that is configured to play a recording of the question displayed on the display screen upon activation of the sound player by the user input device.

### CROSS-REFERENCE TO RELATED APPLICATIONS

This application claims the benefit of U.S. Provisional Application No. 61/022,978 filed Jan. 23, 2008 which is incorporated herein by reference in its entirety.

### FIELD OF THE RELATED ART

This invention relates to administration of quality of life questionnaires for medical research and decision making.

### BACKGROUND OF THE RELATED ART

Capturing health related quality of life information is of significant importance in evaluating the efficacy of the drug in terms of its impact on a patient's life. Quality of life information allows producers of pharmaceuticals, medical devices and other treatment regimes to be able to evaluate how the market will accept their product. For example, a particular drug may be able to cure a patient but shorten life expectancy by five years. Quality of life information can determine whether people would be willing to live an extra five years with pain or five years less completely free of pain.

Quality of life information is gathered using a set of questionnaires. Early questionnaires were administered on paper. For studies requiring the administration of multiple questionnaires, filling them was often a burden to the study participants, as well to research personnel responsible for their administration. Furthermore, complex questionnaires were sometime cumbersome to administer. They required significant involvement from the research personnel and were often difficult to understand by the study participants. This increased the cost of studies to investigators.

Such complex, interactive, questionnaires are the “time trade off” and “standard gamble” questionnaires. Both of these questionnaires, or measures, consist of asking the study participants their preference between two healthcare options. Depending on the option chosen, one option changes and a new scenario is presented. The participants are then asked to choose between two options again. This is repeated several times until the participants cannot decide between the two presented options (i.e., they are indifferent between the options) or until the difference between the two options has reached a certain threshold, defined a priori.

The complexity with the time trade off and the standard gamble is that each new scenario presented to study participants is contingent of the previous answer provided by the participant. When administered in a conventional fashion (pen and paper questionnaire), the time trade off and standard gamble require that all possibilities of answers be defined upfront and included in the questionnaire. The method of choice to determine the nature of the scenarios presented is the “ping-pong” method. This method consists of presenting a scenario to the participant and, depending of the choice between the two options offered, the value in the next scenario will be at mid-range between the maximum and minimum values elicited in previous answers. Thus, it enables collection of quality of life values within 1% sensitivity, even in a minimal number of scenarios presented. This option is hardly used with a pen-and-paper questionnaire, as a very high number of possibilities would need to be incorporated in the questionnaire. To reduce the number of possibilities, study investigators often decide a starting point for the time trade off and standard gamble, and reduce the complexity of the algorithm to decide the next scenario to be presented by using fixed increments that are directional.

For example, the standard gamble commonly presents a first option where a participant is offered to remain the rest of its life in a specific health state (often the current health state of the patients). In the second option, the participant is offered to undergo a hypothetical treatment where there is a probability of being in full health for the remainder of life (p) and a probability of instant death (1−p). When a directional algorithm with fixed increments is used, the first scenario often presents of 50% probability of success and a 50% probability of instant death. Depending on the participant's choice between the two options, the next scenario offered will be presenting a value for “p” equals to “p+” or “p−i”, where “i” is the increment chosen. If an increment of 10% is chosen, there are up to 5 additional scenarios presented to the participants. However, the quality of life values collected that way will all be increments of 10%, reducing the sensitivity of the instrument, and limiting the choices for options. If an increment of 5% is chosen, then the sensitivity of the instrument is accrued, but an additional 10 scenarios may be presented to the study participants, thus increasing the administration burden of the questionnaire. If a sensitivity of 1% is desired for a study, then increments of 1% would be needed, resulting in a potential 50 additional scenarios to be presented to the participant.

Having a directional algorithm may also introduce a bias, as study participants would tend to avoid extremes on the scale (i.e. values close to 0% and 100%) and thus, report preferences between the two presented options that may be underestimated.

A similar reasoning is applicable for the time trade off. In this case, a participant is asked to choose between a first option, remaining the rest of its life in a specific health state, or chose a hypothetical treatment that will always work, will return the participant to perfect health, but may reduce the participant's life expectancy. Based on the participant's choice, the subsequent scenario presents a different life expectancy. This is repeated until the participant cannot decide between options. Because one's life expectancy if strongly influenced by age, it is hardly possible to have a questionnaire with all possible algorithms for the different possible age of participants. Therefore, it is common practice to present the participant with a fixed number of years to live, common to every participant of the study and irrespective of the participant's age. This has the potential of introducing a bias to the study, if the expected difference in age between participants is large. For instance, if 20 years is chosen as the fixed remaining life expectancy, living an additional 20 year for a 65-year old male may have a different meaning than for a 20-year old female. The 20-year old female may not want to try the hypothetical treatment and trade any time because she may not want to die before age 40. On the other hand, the 65 year old male may think that living an additional 20 years is not likely; therefore he may be more willing to try the hypothetical treatment, even if it reduces his life expectancy to 75 years old. In summary, the pen-and-paper method is limited in its possibilities, and hence prone to potential bias.

Moreover, the pen-and-paper method may be open to different interpretation by different people administering the questionnaires, despite the possibility to develop user's manuals in an attempt to standardize their administration. Hence, the pen-and-paper method is prone to potential bias. For instance, both the time trade off and standard gamble instruments require active involvement from the questionnaire administrator. When many people administer the questionnaire simultaneously, there may be issues with consistency regarding the administration of the time trade off and standard gamble (i.e., administrator bias). More explanations given by an administrator and less by another may produce results not homogeneous between all participants (subgroups associated with specific administrators clearly identifiable).

Finally, due the need for graphical representations for both the time trade off and standard gamble, the pen-and-paper method is also very cumbersome, requiring sophisticated boards, which may sometimes be very difficult for transportation. As mentioned above, both the time trade off and standard gamble may require many pre-defined scenarios depending on the algorithm use to present them to the study participants. One particularity of these two instruments is that each scenario is graphically depicted to facilitate participants' understanding. The higher the number of scenarios, the higher the number of graphics needed in the questionnaire. This result in very sophisticated boards, usually over-sized compared to standard questionnaires, difficult to administer and to transport. Thus, there is a need for a tool that automates and simplifies the collection analysis and reporting of quality of life data. There is also a need for a user friendly method that can be self-administered by a patient to reduce the labor intensity of quality of life survey administration. There is a need for an elimination of survey error caused by administrator to administrator discrepancies. The present invention addresses these and other needs.

### SUMMARY OF THE INVENTION

The present invention includes in one embodiment, a computer survey system comprising a microprocessor, a display screen, a user input device and a database all in communication with the microprocessor. The microprocessor activates software that systematically administers a quality of life survey by displaying a plurality of quality of life questions on the display screen. The software requests responses from the patient using a user input device and stores the response in a database. The system further has a sound player that is configured to play a recording of the question displayed on the display screen upon activation of the sound player by the user input device.

In one embodiment, the input device is a keypad, touchpad or a mouse device.

In another embodiment, the sound player is a computer media player with speakers.

In still another embodiment, the display is a computer monitor.

In one embodiment, the computer system is a web-based system and the software and database is stored on a web-server that is remote from the user, the display screen, the sound player and the user input device.

In another embodiment, the computer survey system includes a plurality of quality of life questionnaires, directed to individual health state question; the system further comprises randomizer that administers the plurality of life questionnaires in random order to the user.

In still another embodiment, the software administers a quality of life questionnaire that comprises a first quality of life question and generates a second quality of life question based upon the response to the first quality of life question using the ping pong method.

In one embodiment, the survey is a time tradeoff questionnaire or a standard gamble questionnaire.

In still yet another embodiment, the survey is a time tradeoff questionnaire and the display displays a time-tradeoff question, a first bar graph representing a first life expectancy of the time trade off question, a second bar graph representing a second life expectancy of the time trade off question.

In still yet another embodiment, the survey is a standard gamble questionnaire and the display displays a standard gamble question, a pie chart representing a first life expectancy of the time trade off question, a second pie chart representing a second life expectancy of the time trade off question.

In one embodiment, the software is a PC based software.

Because of the burden of administration of the time trade off and standard gamble, at least one embodiment of the present invention includes a system comprising a computer that administers the standard gamble and the time trade off quality of life surveys to a patient and gives the advantage of increasing the sensitivity of the measures. This is because a mathematical algorithm is used to choose the scenario to be presented to the study participants based on the previous answers.

It also enables the possibility of using the ‘ping-pong’ method for varying the probabilities (for the standard gamble) or remaining life expectancy (for time trade off) instead of relying on an incremental algorithm. The ‘ping-pong’ method consists of presenting a scenario to the participant and, depending of the choice between the two options offered, the value in the next scenario will be at mid-range between the maximum and minimum values elicited in previous answers. Thus, it enables collection of quality of life values within 1% sensitivity, even in a minimal number of scenarios presented.

For instance, if the value for p in the standard gamble instrument is 50% in the first scenario. A participant willing to take such a risk to try a hypothetical treatment will be presented with a new scenario where p=25%. If the participant is not willing to take such a risk, the next value for p will be 38%. This is calculated by taking the average of the previous p value (50%) and the new p value (25%) and adding the average of these two p halves to the new p value and rounding it to the next integer. Therefore, the maximum number of scenarios presented rarely exceeds seven, compared to 50 in the paper version of the instrument.

One additional advantage to computerize the time trade off and standard gamble is associated with the possibility of mathematically determining the presented remaining life expectancy of participants, according to their age and gender. Using a custom-derived formula based on census life tables, it is possible to estimate the life expectancy of a participant after asking age and gender. This has the effect of potentially reducing the bias associated with using a fixed remaining life expectancy.

Another advantage is consistency between several administrators. Because of a voice-over add-on component of the electronic quality of life survey tool, minimal intervention from the interviewer is needed and common directives are given to study participants, regardless of the number of interviewers. This tends to minimize the administrator bias often seen with questionnaires administered with the pen-and-paper method. The sound player enables a “voice-over” feature and consists of a recording of the text that appears on the screen, as well as audio confirmation messages helping the participant navigate through the tool. This helps in increasing the consistency of response between participants as not only they can read the information on the screen, but hear an identical recording of the question text. The risk of misinterpreting the questions or bias introduced by different personalities administering the same survey because the recording is identical from one survey participant to the next survey participant. The sound recording can also be helpful with survey participants that are treatment patients in a clinical trial and are seeing impaired.

This also reduces the chances of error introduced when a survey participant answers a question without reading all the information presented (answering too fast). In addition, the voice-over add-on also help maintain the tone of administration, as the participants are less influenced by the qualities of the interviewer, since his/her role is minimal in the administration of the questionnaire. Standardization in time of administration and tone of administration helps reduce the bias compared to a traditional pen-and-paper option.

Also, the cumbersome survey display boards associated with traditional pen and paper method of administering quality of life surveys can be avoided altogether with the availability of having the data collected electronically, whether on desk or laptop computers, or even online. Errors related to the manuscript transcription of the survey results can be avoided as the electronic quality of life survey tool is not only connected to a database, but also includes real-time audit checks so that missing or out of range values are minimized.

### BRIEF DESCRIPTION OF THE DRAWINGS

FIG. 1 is the welcome screen of the electronic quality of life survey tool of one embodiment of the present invention.

FIG. 2 is an illustration of the menu bar of the software of one embodiment of the present invention.

FIG. 3 is an illustration of a shortcut panel of one embodiment of the present invention.

FIG. 4 illustrates the main panel of the welcome screen of FIG. 1.

FIG. 5 is an illustration of the main panel of an introduction module for a quality of life questionnaire.

FIG. 6 is an illustration of a main panel setting forth the health state description for a time trade off questionnaire.

FIG. 7 is an illustration of a main panel showing a first instruction page for the time trade off questionnaire.

FIG. 8 is an illustration of a main panel showing a second instruction page for the time trade off questionnaire.

FIG. 9 is an illustration of the main panel showing an actual time trade off question and alternative option 2 scenario choices that may be encountered in subsequent iterations of the survey.

FIG. 10 is an illustration of a main panel showing a first instruction page for the standard gamble questionnaire.

FIG. 11 is an illustration of a main panel showing a second instruction page for the standard gamble questionnaire.

FIG. 12 is an illustration of the main panel showing an actual standard gamble question and alternative option 2 scenario choices that may be encountered in subsequent iterations of the survey.

FIG. 13 is an illustration of the navigational panel of the software and the sound control of the present invention.

### DETAILED DESCRIPTION OF THE INVENTION

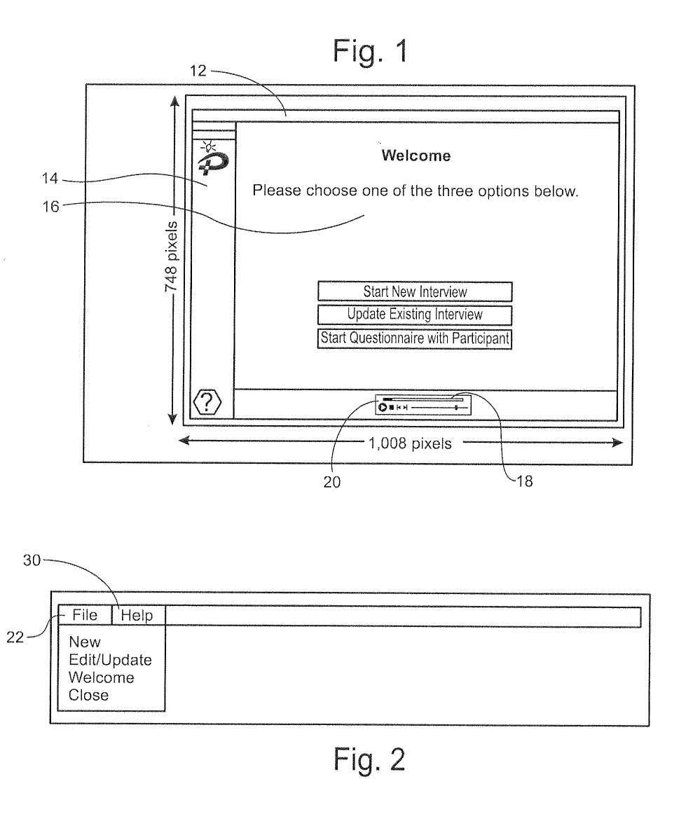

With reference to FIG. 1, the electronic quality of life survey tool is a computerized instrument aimed at capturing quality of life and/or health utilities from participants from the general public or from patients. The electronic quality of life survey tool illustrates the welcome screen 10 of the survey and is composed of five (5) sections including a menu bar 12 for selecting menu options for the software, the shortcuts panel 14, the main panel 16 that displays introductory options, the navigation panel 18, and the voice-over controls or controls for the sound recorder 20.

The minimum size of the electronic quality of life survey tool in one embodiment is 1,008 X 748 pixels, thus it requires a screen resolution of at least 1,024 X 768 to be properly displayed. The electronic quality of life survey tool can be maximized to full screen.

The menu bar of the present invention is shown in FIG. 2. It is fully customizable. It includes a file menu 22 with various options. One option is to create a new data entry. Another option is to edit or update an existing data entry. A third option quickly accesses the Welcome Page. The fourth option closes the electronic quality of life survey tool. Additionally or optionally, other selections such as ‘export data’ and ‘create report’ can be added by a person of ordinary skill in the art.

In one embodiment, the menu bar includes a Help selection 30 to access help files. An ‘About’ selection (not shown) is optionally present and shows information about the version being used.

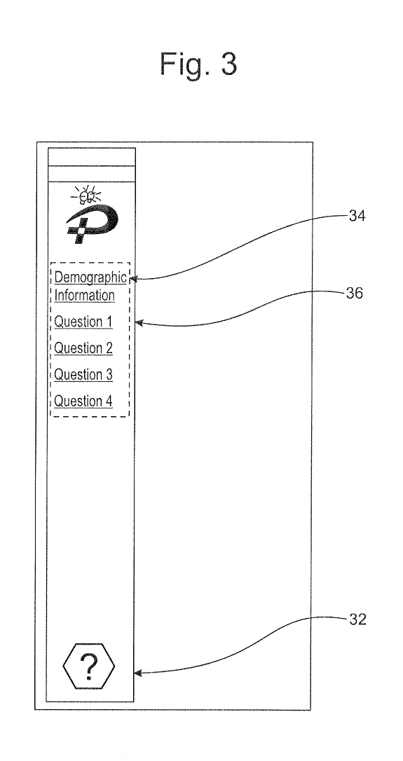

FIG. 3 illustrates a shortcut panel of one embodiment of the present invention. Optionally, the shortcuts panel is a fixed-width panel that includes a help button 32. In addition, shortcuts to specific parts of the electronic quality of life survey tool can be incorporated. For example, a Demographic Information button directs the participant or administrator to Demographic Information page where demographic information of the participant can be added, modified, updated or referenced. In one embodiment, four questions (or series of questions) representing four different health state issues are used in the survey. Buttons 36 can access the series of questions 1-4 respectively.

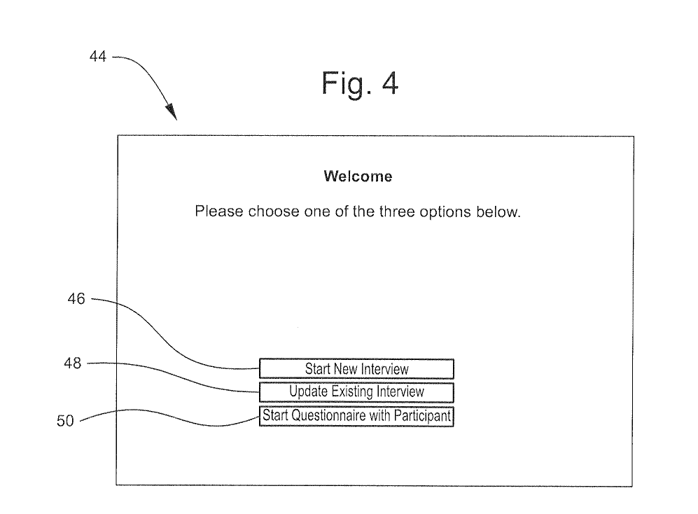

FIG. 4 illustrates the Main Panel 44, the dynamic section of the electronic quality of life survey tool. Shown here with the welcome page, the main panel also serves as a display and placeholder for the different modules contained in the electronic quality of life survey tool. Each module will appear as a ‘page’ appearing in the Main Panel. The welcome module or welcome page contains three selections. The first selection or button 46 directs the participant or administrator to a page or module for beginning a new interview. A second selection or button 48 directs the participant or administrator to update an existing interview or continue an interview in progress. A third selection 50 directs to a page or module that starts a questionnaire with the participant. Additional buttons can be added, such as a button to open a new form to enter a patient's medical history.

Alternatively or optional is, the Main Panel can contain one module that serves to collect demographic information from the study participants, to introduce concepts (such as health states), and to collect health utilities based on participants' own health state or based on described health state scenarios.

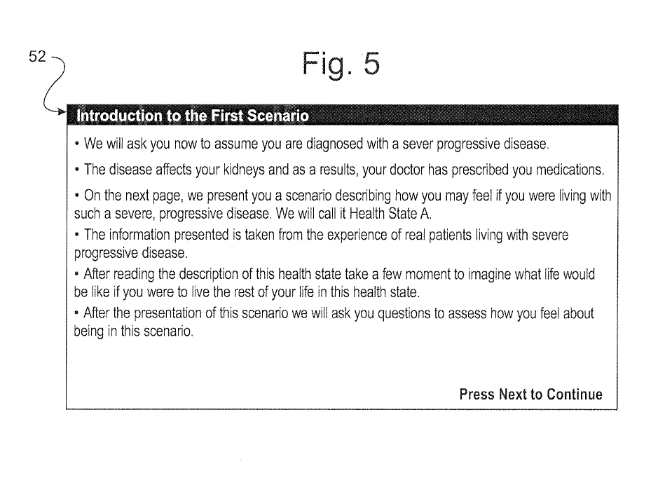

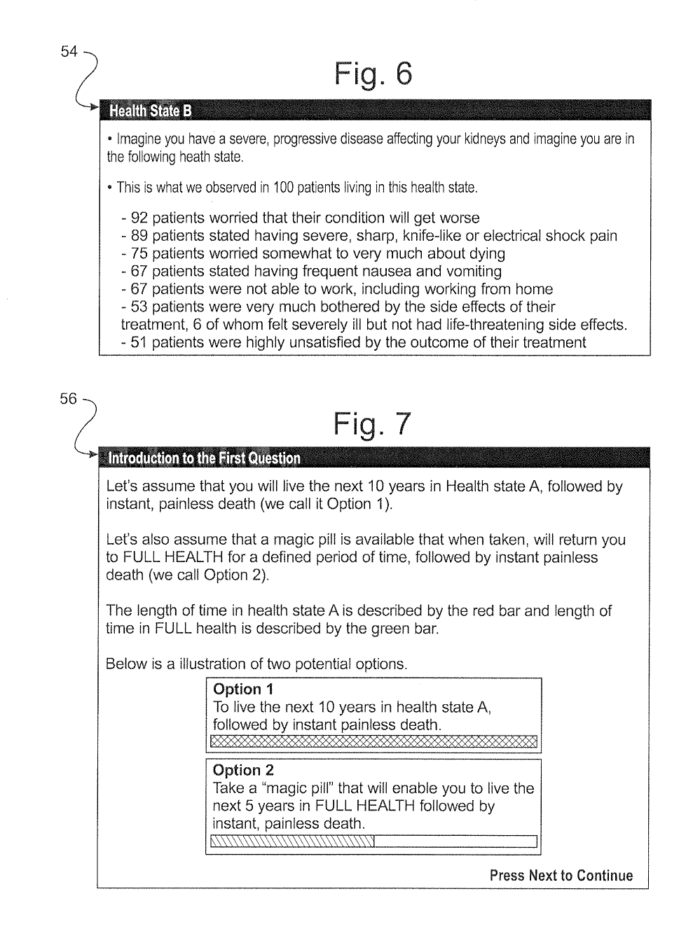

Example of other modules loaded in the Main Panel are the introduction module 52 to explain to the participants the study details (FIG. 5) and health state description modules 54 to describe specific health states to participants, when the electronic quality of life survey tool is administered to member of the general public (FIG. 6).

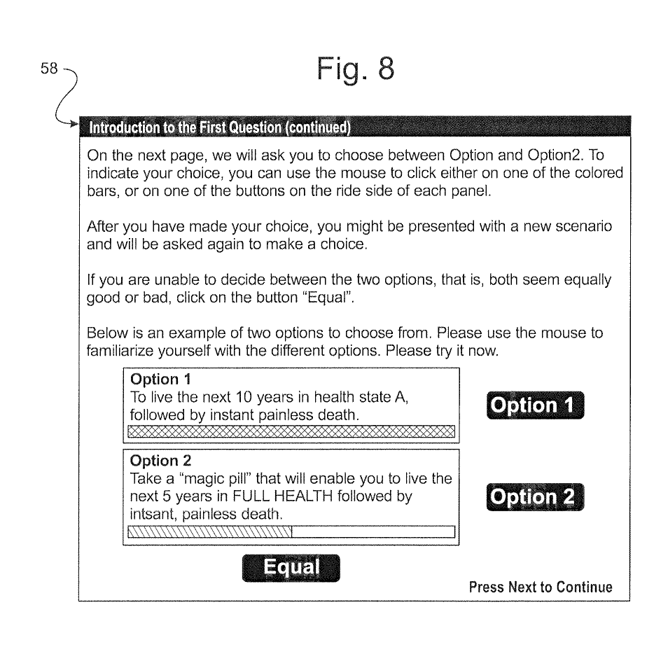

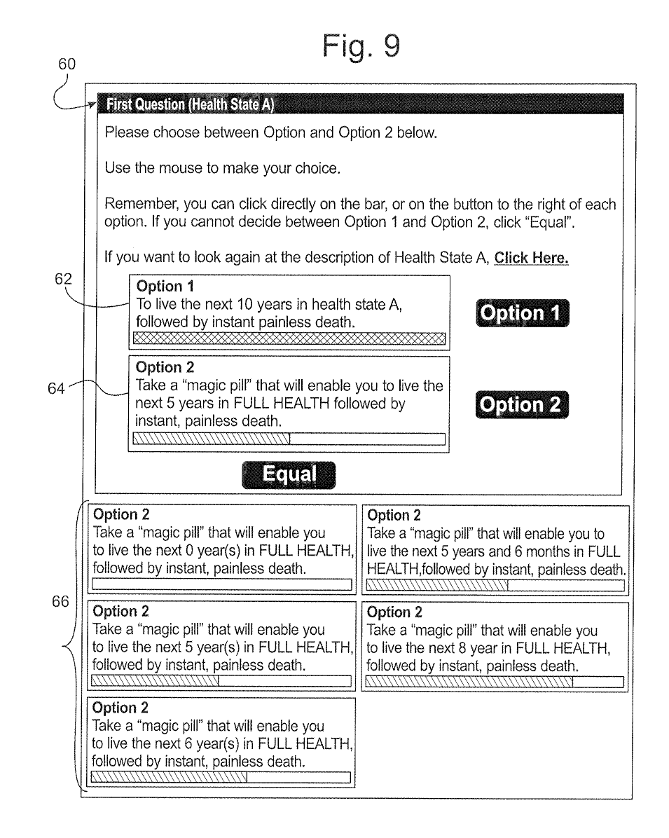

One of the two main measures of the electronic quality of life survey tool is the time trade off survey. The first time it is presented to a participant, it is composed of three modules. Introduction #1 (see 56 of FIG. 7), Introduction 2 (see 58 of FIG. 8), and the actual time trade off questions (see 59 of FIG. 9).

The time trade off module of the present invention is dynamic in nature. It presents two options and request the participant's input. The participant is asked to choose between option 1 (62) and option 2 (64). The two options are illustrated in the form of a bar-type graph. The total length of the bar represents the total life expectancy of the survey. The portion of the bar that is colored is a statistically accurate visual representation of the relative length of time of the option choice.

As the survey proceeds, option 1 remains constant, but option 2 varies until the participant cannot decide which of the two options he/she prefers. The option 2 in one embodiment is calculated based upon the participant response to the previous two options using the ping pong method and formula described above. The length of time in both options is likewise calculated factoring in age, life expectancy and health statistics to eliminate age and health state bias in the survey.

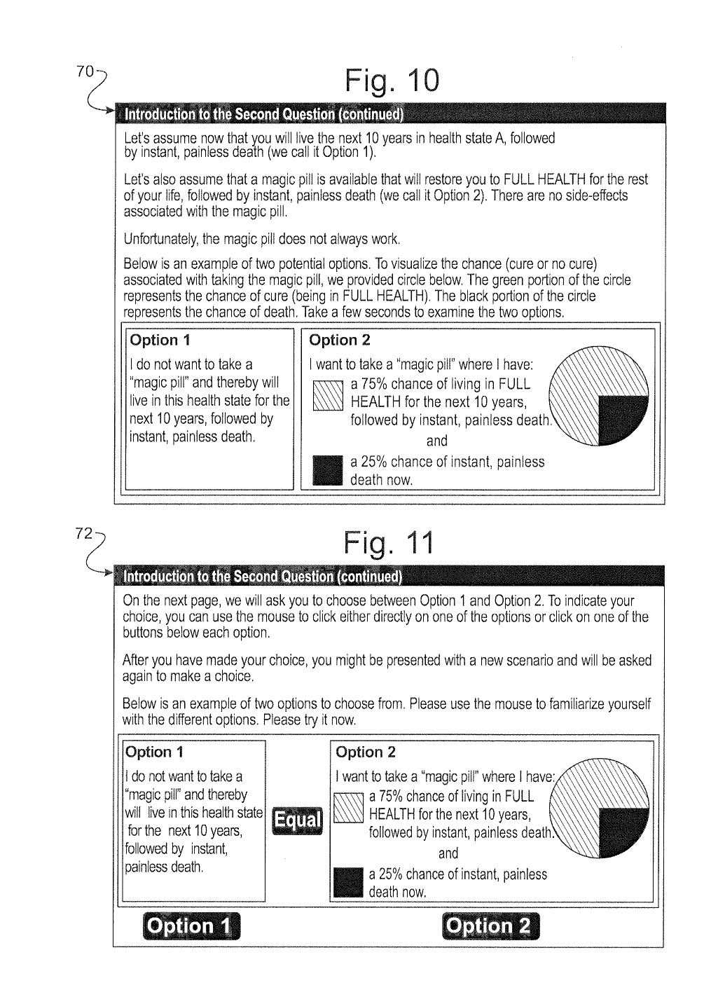

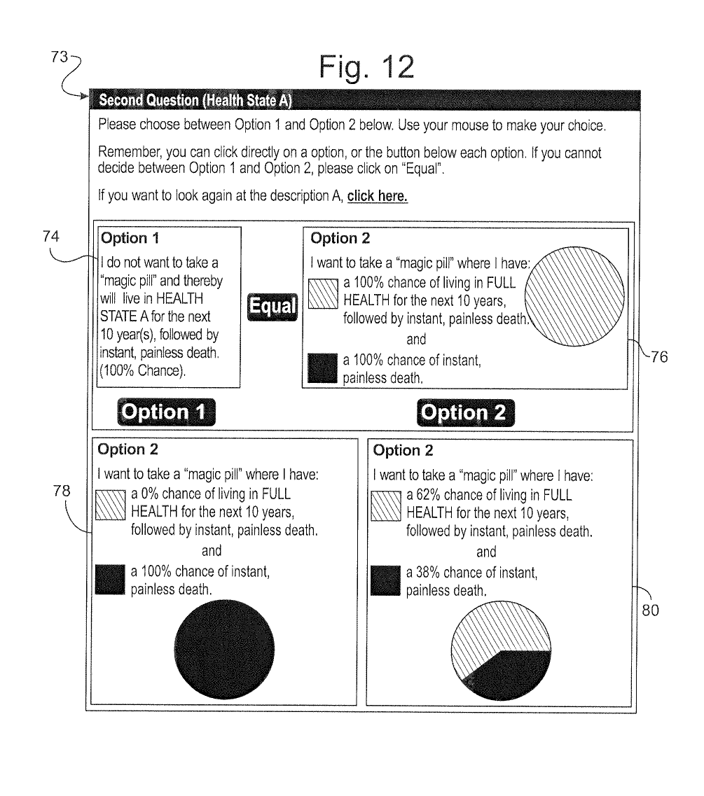

The second main measure of the electronic quality of life survey tool is the standard gamble survey. The software presents the standard gamble survey to the participant for the first time with three modules. The first page is an introduction page 70. See FIG. 10. The second page 72 is also an introduction page. See FIG. 11. These two introduction pages explain the scenario and choice of the standard gamble survey. Then, the actual standard gamble survey commences with a survey page 73 with two options 74 and 76 and a choice. See FIG. 12

The standard gamble module is a dynamic module. It presents two options and request the participant's input. The participant is asked to choose between option 1 and option 2. Option 1 remains constant throughout the series of related questions, but option 2 varies until the participant cannot decide which of the two options he/she prefers. As shown in FIG. 12, multiple potential subsequent choices are illustrated 78 and 80. The subsequent gamble questions of option 2 are calculated based upon the participant's response to the previous question using the algorithm disclosed above.

Different modules can be added to the electronic quality of life survey tool, depending on the study needs. In addition to collecting demographic information, answers to the time trade off and standard gamble for one or more health states, other information can be collected. For instance, if the electronic quality of life survey tool is administered to participants, a module collecting past medical history on their disease can be added. In addition, if additional questionnaires are required to be administered, such as the Health Utility Index Mark-3 and the Euroquality of life eQ-5D, they can be loaded as separate modules instead of being administered concomitantly using a pen-and-paper approach.

In one embodiment, the software administers a plurality of questionnaires each dealing with a different health state. Optionally, each health state involves a standard gamble survey and a time trade off survey. A randomizer software component is used to ensure that all participants are administered questions about the different multiple health states in random order. This avoids error caused by subsequently administering the different health state questionnaires in a particular order. The computer randomizer is more effective in ensuring that the different health state questionnaires are administered randomly than when individuals are administering the survey.

Another important feature is a comparative health state ranking that is optionally administered by the software program after each health state questionnaire is answered. The participant is asked to rank the various health state conditions in relative degree of severity. Then, this information is used, among other potential uses, to verify the effectiveness of the survey. A high correlation between the answers to the health state questionnaires using the time-trade off method and/or the standard gamble method on the one hand and the participant ranking of health state severity on the other hand shows a considerable degree of survey efficacy.

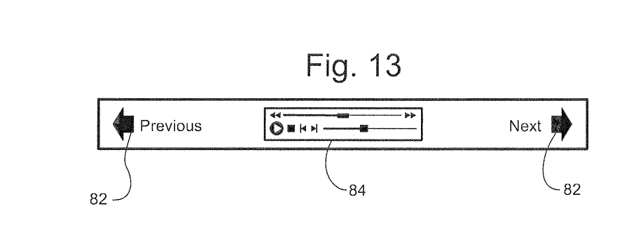

With reference to FIG. 13, the navigation panel 82 is located below the main panel and helps the participants navigate between the ‘pages’ (modules) of the electronic quality of life survey tool.

FIG. 13 also illustrates one important tool of the software of the present invention—the sound player including a speaker system and a computer sound control 84. The sound control helps guide participants through the electronic quality of life survey tool. The participant can listen to a voice reading the text displayed on the screen while they follow along reading the text and viewing a graphic representation of the options. This multi-media approach ensures that both audio and visual feedback is present to minimize the participant misunderstanding the invention.

In addition, in modules where the participant's input is requested, a voice feedback confirms the choice that has been made by the participant. The sound player can be controlled by the computer sound control similar to a media player that enables the user to play, stop, rewind, mute and adjust the volume of the voice over. The voice-over add-on can be adapted to any studies and recorded in many languages/accents, at the request of the survey sponsor. One example of a sound player is Windows Media Player by Microsoft.

In one embodiment, the software is optionally web-based. The web based software enables studies in multiple cities, multiple countries at minimal cost. Data transfer can be made to a central location instantly for analysis. Multiple language audio recordings and written instructions can be administered in a single survey. Due to the user friendly nature of the computer software. Participants can self administer their surveys. A significantly larger sample size for studies can be employed at considerable cost savings. Cultural preferences relating to different markets can be more readily assessed to permit more accurate participant preference data to affect go/no go product development and marketing decisions for pharmaceutical and other health related products.

### EXAMPLE

A statistically significant sampler style is divided into two groups of participants. The two groups are administered questionnaires relating to four different health states. The control group is administered using the pen and paper method. The study group is administered using PharmIdeas Quality of Life Survey Software Tool available from PharmIdeas, Oakville, Ontario, Canada.

The program administrators for the control group are given multiple display panels for various health state questionnaires and are asked to administer the survey using ping pong method manually calculated. Each instruction and question is to be read to the participant. Each response is to be verbally confirmed. The panels are designed to resemble the computer screen choices of the software program by PharmIdeas. Both the time trade off method and the standard gamble method 15 is used for each survey. Biographical and demographic data is collected for each participant including sex, age, medical history, family medical history and other information needed to estimate life expectancy.

The administrators for the control group are requested to randomly choose the order of administration of the survey for each of the four health states. At the end of the four surveys relating to the different health states, an additional survey that requests the survey participants to rank the four health states in degree of relative severity listing from most severe to least severe. Survey participants are also asked to rank on a scale of 1 to 10 (one being the most dis-favorable ranking and 10 being the most favorable ranking) the overall favorability of the survey. Finally, data is collected on the time required to administer each survey.

The program administrators for the study group are given PC laptops with the PharmIdeas Quality of Life Survey Tool. The same four health states surveys are administered using the same questionnaires used by the control group in generally the same manner. The ping pong method is used to automatically calculate life the subsequent survey options. However, the sound player is used to read every instruction, question and response to the survey instead of the administrator. The four health state questionnaires are administered randomly by the PharmIdeas software randomizer.

At the end of the four questionnaires relating to four separate health states an additional survey that requests the survey participants to rank the four health states in severity. Survey participants are also asked to rank on a scale of 1 to 10 (one being the most dis-favorable ranking and 10 being the most favorable ranking) the overall favorability of the survey. Finally, data is collected on the time required to administer each survey.

The results are that the study group has a statistically significant higher correlation between the severity ranking at the end of the survey and the participant responses to the questionnaires than the control group. The study group has a correlation higher than 70%. The control group has a lower favorability ranking than the study group. Moreover, it takes significantly longer to administer the survey using the pen and paper method than the software tool.

What is claimed is:

1. A computer survey system comprising a microprocessor, a display screen, a user input device and a database all in communication with the microprocessor, wherein the microprocessor activates software that systematically administers a quality of life survey by displaying a plurality of quality of life questions on the display screen and requests responses from the participant using a user input device and stores the response in a database, the system further having a sound player that is configured to play a recording of the question displayed on the display screen upon activation of the sound player by the user input device.

2. The computer system of claim 1, wherein the input device is a keypad, touchpad or a mouse device.

3. The computer system of claim 1, wherein the sound player is a computer media player and speakers.

4. The computer system of claim 1, wherein the display is a computer monitor.

5. The computer system of claim 1, wherein the system is web-based system and the software and database is stored on a web-server that is remote from the user, the display screen, the sound player and the user input device.

6. The computer survey system of claim 1, wherein the survey includes a plurality of quality of life questionnaires, each questionnaire addressing a different participant health state, the system further comprises randomizer that administers the plurality of life questionnaires in random order to the user.

7. The computer system of claim 1, wherein the software administers a quality of life questionnaire that comprises a first quality of life question and generates a second quality of life question based upon the response to the first quality of life question using the ping pong method.

8. The computer system of claim 1, wherein the survey is selected from the group comprising the time tradeoff questionnaire or a standard gamble questionnaire.

9. The computer system of claim 1, wherein the survey is a time tradeoff questionnaire and the display displays a time-tradeoff question, a first bar graph representing a first life expectancy of the time trade off question, a second bar graph representing a second life expectancy of the time trade off question.

10. The computer system of claim 1, wherein the software is a PC based software.

11. The computer system of claim 1, wherein the survey includes a plurality of quality of life questionnaires, each questionnaire addressing a different participant health state, the system further comprises randomizer that administers the plurality of life questionnaires in random order to the user, the system further includes a participant ranking of the severity of the different health states, wherein the correlation of the participant ranking to participant response to the survey is greater than 70 percent.
